(19) United States
(12) Patent Application Publication
(10) Pub. No.: US 2021/0158439 A1
(43) Pub. Date: May 27, 2021

(54) Method for Optimizing Usage Savings in Financial Accounts

(71) Applicant: GigaPoints, Inc., San Carlos, CA (US)

(72) Inventor: Erik Budde, San Carlos, CA (US)

(73) Assignee: GigaPoints, Inc., San Carlos, CA (US)

(21) Appl. No.: 17/102,417

(22) Filed: Nov. 23, 2020

Related U.S. Application Data
(60) Provisional application No. 62/939,547, filed on Nov. 22, 2019.

(51) Int. Cl. G06Q 40/02; G06Q 40/06; G06Q 30/02

(52) U.S. Cl. CPC G06Q 40/025; G06Q 40/06; G06Q 30/0236; G06Q 30/0213; G06Q 30/0234; G06Q 30/0224; G06Q 30/0208; G06Q 30/0226

(57) ABSTRACT

A computer-implemented method for optimizing the selection of a financial account by a user including causing at least one computer to analyze a transaction history of the user on an existing spending account of the user to determine any savings earned by the user on the existing spending account over the transaction history. The transaction history of the user is mapped by the at least one computer to each of a plurality of additional financial accounts. The at least one computer determines any savings that would be earned by the user as a function of the transaction history for each of the plurality of additional financial accounts and delivers to the user a recommendation for optimizing financial account savings that includes using at least one of the plurality of additional financial accounts.

### CROSS REFERENCE TO RELATED APPLICATION

This application claims priority to U.S. provisional patent application Ser. No. 62/939,547 filed Nov. 22, 2019, the entire content of which is incorporated herein by this reference.

### FIELD OF THE INVENTION

This invention relates to financial accounts, and more particularly to optimizing rewards provided by financial accounts.

### BACKGROUND OF THE INVENTION

With more than 3,000 major credit cards available, it is hard for consumers to determine which card is the optimal card for them. Each card has different costs, for example annual fees and interest rates, as well as benefits, which can be extremely significant. Existing solutions force a consumer to read and analyze much content, and manually apply it to the consumer's spending habits, to assist the consumer in selecting the right card.

There is a need for a computerized method for assisting a consumer in the selection of one or more credit cards, or other financial accounts, that provide optimal usage savings to the consumer.

### BRIEF DESCRIPTION OF THE DRAWINGS

The drawings herein are schematic and not drawn to scale and are for illustration purposes only and are not intended to limit the scope of the present disclosure.

FIG. 1 is a schematic view of an embodiment of a computer system of the invention.

FIG. 2 is an embodiment of a display page illustrating a comparison step of an embodiment of a computerized method of the invention, which can operate on a computer system of the invention.

FIG. 3 is an embodiment of a display page illustrating the results of an embodiment of an analysis step of spending in a current account of a user in the computerized method of the invention.

FIG. 4 is an embodiment of a display page illustrating the results of an embodiment of an analysis step of rewards in a plurality of current accounts of a user in the computerized method of the invention.

FIG. 5 is an embodiment of a display page illustrating the results of an embodiment of a recommended accounts step of the computerized method of the invention.

FIG. 6 is an embodiment of a display page illustrating the highlights of an embodiment of a recommended accounts step of the computerized method of the invention.

FIG. 7 is an embodiment of a display page illustrating the results of an embodiment of a standardization step of the computerized method of the invention.

FIG. 8 is an embodiment of a display page illustrating the results of an embodiment of a rewards analysis step of the computerized method of the invention.

FIG. 9 is an embodiment of a display page illustrating the results of an embodiment of a rewards analysis of the computerized method of the invention.

FIG. 10 is an embodiment of a display page illustrating the results of an embodiment of a rewards analysis step of the computerized method of the invention.

FIG. 11 is an embodiment of a display page illustrating the results of an embodiment of a rewards analysis step of the computerized method of the invention.

FIG. 12 is an embodiment of a display page illustrating the results of an embodiment of a rewards analysis step of the computerized method of the invention.

FIG. 13 is an embodiment of a display page illustrating the results of an embodiment of a rewards analysis step comparing a plurality of recommended accounts of the computerized method of the invention.

FIG. 14 is an embodiment of a display page illustrating a filter selection step of recommended accounts of an embodiment of the computerized method of the invention.

FIG. 15 is an embodiment of a display page illustrating the filtered results of an embodiment of a rewards analysis step comparing a plurality of recommended accounts of the computerized method of the invention.

FIG. 16 is an embodiment of a display page illustrating the filtered results of an embodiment of a rewards analysis step comparing a plurality of recommended accounts of the computerized method of the invention.

FIG. 17 is an embodiment of a display page illustrating the filtered results of an embodiment of a rewards analysis step comparing a plurality of recommended accounts of the computerized method of the invention.

FIG. 18 is an embodiment of a display page illustrating a filter selection step of an embodiment of the computerized method of the invention.

### DETAILED DESCRIPTION OF THE INVENTION

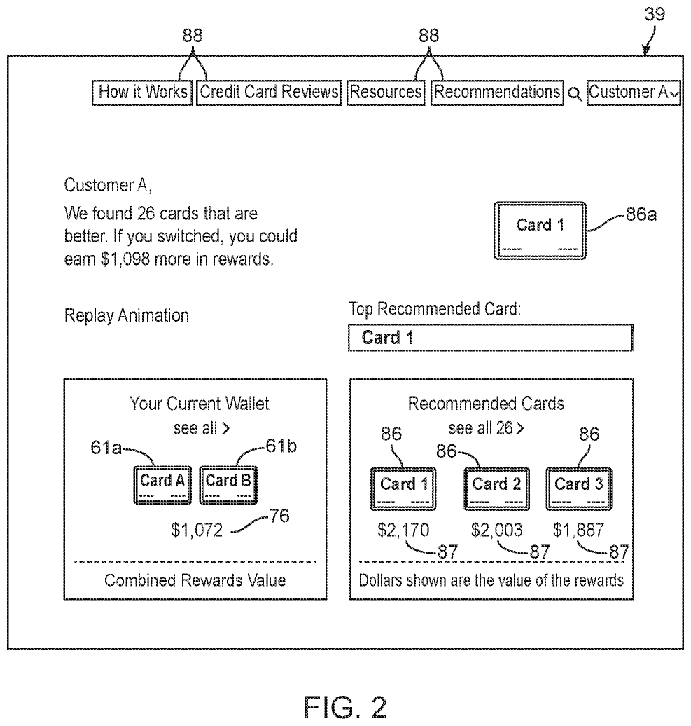

In one aspect of the invention, a user's past credit card, debit card, checking account, savings account, investment account, financial account, other spending data or any combination of the foregoing is collected and utilized by a system and computerized method of the invention to model how much the user would earn, including for example net of costs, using one or more possibly different cards or financial accounts (see FIG. 2). The system and computerized method, which can be referred to as an algorithmic method or computer-implemented method, can produce clear, easy and accurate recommendations in comparison to current prior art systems and methods for assisting users in the selection of credit or other financial accounts optimal to a user's spending habits.

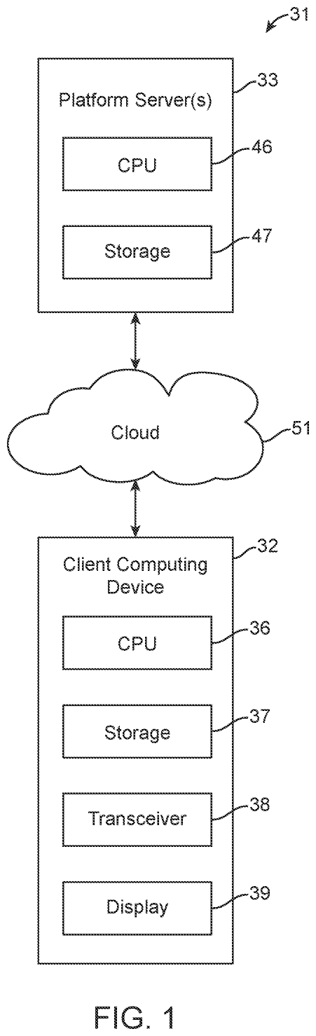

The system of the invention can include at least one computer or computing device configured to control all or parts of the method and system of the invention, including for example system 31 shown in FIG. 1. The at least one computing device can optionally be programmed with firmware, software or both to control all or parts of the method and system of the invention. The at least one computing device can optionally have computer-executable instructions stored in a non-transitory computer-readable storage medium to control all or parts of the system. The at least one computing device can optionally include a computing device associated with the user or consumer, who can also be referred to as the client, for example client computing device 32 in FIG. 1. The at least one computing device can optionally include one or more backend servers or other computing devices remote of the user or consumer, which can be referred to as cloud computers or servers, cloud-based computers or servers or platform computers or servers, for assisting in or accomplishing any of the tasks of the system. Such backend servers or other computing devices can include, for example, platform servers 33 in FIG. 1. Servers of the system, for example servers 33, can be located in a data center, which can be referred to as a cloud computing center. The at least one computing device can include a network of computing devices, which can be referred to as a computer network.

Examples of suitable computing devices, for example suitable client computing devices 32, include desktop computers, laptop computers, notebook computers, entertainment systems, smart home or other devices, internet of thing devices, network appliances, intelligent personal assistants, tablets, smartphones, mobile computing devices, mobile phones, watches, wearable electronic devices, smart wearable devices, electronic headsets, virtual-reality devices or any combination of the foregoing.

Each computing device of the system can include a central processing unit (CPU) and storage or memory of any suitable type. Each computing device can optionally include a display and a user interface, which can be a display. Each computing device can optionally include a transceiver, which can be referred to as a radio, for permitting wireless communications with the computing device. In this regard, for example, each client computing device 32 can optionally include a CPU 36, storage 37, a transceiver 38 and a display 39. Each platform server 33, for example, can include a CPU 46 and storage 47.

The non-transitory computer-executable instructions, or software or firmware, of the system can be stored or located in any, some or all of the computing devices of the system, and can be executed by any, some or all of the computing devices of the system. For example, the non-transitory computer-executable instructions, or software or firmware, of system 31 can be stored or located in any, some or all of client computing device 32 and platform servers 33, and can be executed by any, some or all of client computing device 32 and platform servers 33. The user can access system 31 by any suitable means, including for example a web browser or a downloadable or other application.

Each of the components of the system can communicate with at least some of the other components, or all of the other components, of the system by any wireless, hard-wired or Internet-based means, which can be referred to as or include the cloud. For example, each of the components of system 31 can communicate with at least some of the other components, or all of the other components, of system 31 by any wireless, hard-wired or Internet-based means, which can be referred to as or include cloud 51 shown in FIG. 1.

A method of the invention can optionally include providing a transaction history, which can be referred to as transaction data, of the user on an existing spending or financial account of the user. In this regard, the method of the invention can optionally include accessing one or more financial accounts of a user at a financial institution for evaluation, for example computerized evaluation. Such spending or financial accounts can optionally include credit card accounts, debit accounts, checking accounts, savings accounts, investment accounts or any combination of the foregoing. For example, a user can optionally create an account or profile in the system 31, for example via the user's client computing device 32. As part of the account creation, the user's e-mail and password can be stored in the system to enable system results to be stored securely. In another optional step, the user can input information from one or more financial accounts into the system 31. For example, the user can optionally click on a link to add existing credit card, banking, investment, spending or other financial accounts to the user's account or profile in the system 31. The system 31 can then access detailed historical and other information from each of these accounts in any suitable secure manner. For example, access to the user's financial information may be obtained through a data aggregator, for example Plaid Inc., through a direct connection with financial institutions of the user, through indirect access such as “scraping” or any combination of the foregoing.

Once such access is successfully granted or obtained, system 31 can optionally obtain detailed historical and other financial information of the user. For example, the system can download the user's credit card, debit card, financial accounts or other spending transactions for analysis. The system 31 can optionally receive data for all cards or accounts of the user with the selected financial institution. The transaction data of the user is stored in computer system 31, for example in storage 47, storage 37 or both, and can optionally be stored in one or more databases of the system 31.

The user can optionally choose to add different credit cards, debit cards or other financial accounts at the selected financial institution but with different login information to the user's profile or account in system 31 for analysis.

The user can optionally choose to add additional financial institutions or accounts to the user's profile or account in system 31 for analysis. For example, credit cards, debit cards or other spending transactions in one or more financial accounts at a different bank or financial institution can be added to the user's profile for analysis. The user can optionally enter all accounts of the user, or the accounts of the user that represent 100% of the spending of the user, for analysis by system 31.

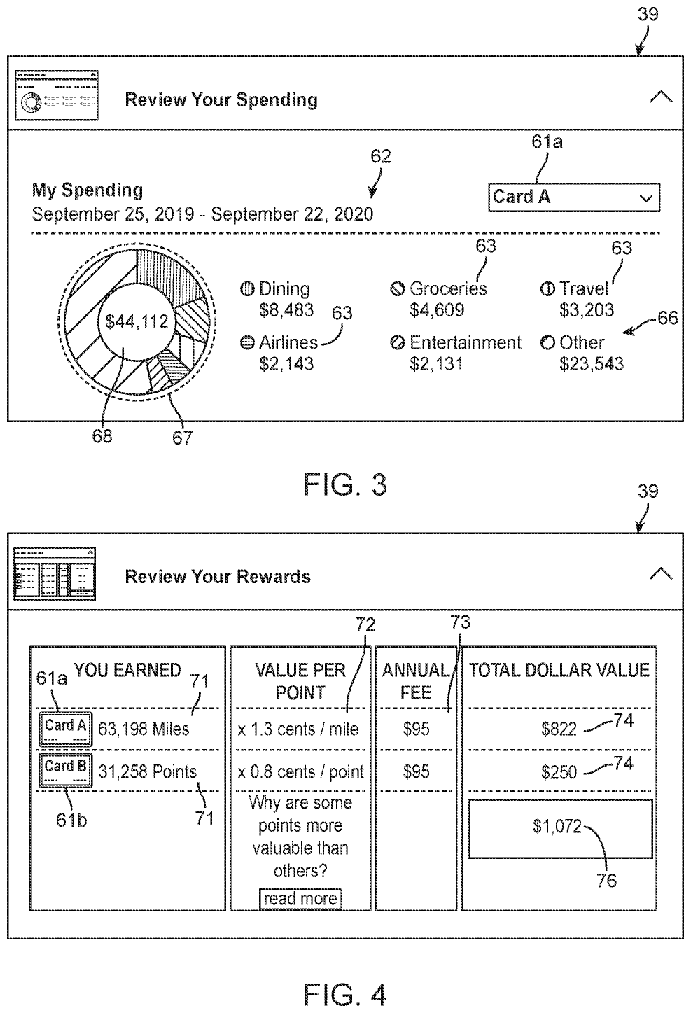

The computerized method of system 31 can optionally analyze the transaction history of the user, for example the spending history or data of the user. For example, the system can optionally analyze the transaction history of each account of the user, for example each credit card account of the user. Such analyzing step can optionally include determining the amount of spending of the user in each of a plurality of predetermined or computer determined spending categories. The predetermined spending categories can be of any type, and for example can optionally include base spending, travel spending, airfare spending, grocery spending, food spending, dining spending, entertainment spending, accommodation spending, hotel spending, office supply spending, business spending, merchant spending, home improvement spending or any combination of the foregoing. System 31 can optionally present the spending categories, including the user's spending in each category, to the user, for example communicated to display 39 of client computing device 32 of the user. The spending can be provided in one or more currencies. A sample presentation to the user of the spending categories is shown in FIG. 3 for a specific or selected financial account 61 of the user, for example first user account 61a, over a predetermined or selected time period 62. Each category 63, and the spending within the user account 61a in each category 63, can be shown in any suitable manner. In the sample presentation shown in FIG. 3, each category 63 is shown in both written form 66 and graphical form 67. The total spending 68 of the user in the selected account 61a can optionally be included in the presentation to the user.

The computerized method of system 31 can optionally calculate the amount of savings, for example rewards or spending rewards, that can be generated by the one or more existing financial accounts of the user to which system 31 has been granted access. The system 31 can apply all of the data available to it on what, if anything, the one or more financial accounts earn, for example whether it be miles, points or cash back. System can optionally value, for example standardize, each of these rewards savings in a currency, for example in dollars.

For example in this regards, he computerized method of system 31 can optionally analyze a specified or selected transaction history of the user on one or more, for example each, of the selected financial accounts 61 of the user to determine any savings earned by the user. The savings earned by the user can be, for example, rewards points earned by the user in a rewards program for each of the one or more selected financial accounts of the user. The rewards analysis can optionally break down the earned rewards for each financial account 61 of the user by any number of reward categories, can optionally translate or standardize the earned rewards into a dollar value, can optionally deduct any annual fee of the account 61 from the earned rewards dollar value and can optionally provide a total dollar or other currency value of the earned rewards for the account. System 31 can optionally present the results of some or all of the earned rewards analysis to the user, for example communicated to display 39 of client computing device 32 of the user. A sample presentation to the user of the rewards analysis results is shown in FIG. 4 for a first user account 61a and second user account 61b of the user. The sample presentation includes the total rewards 71 for each account 61a, 61b, for example in miles or points, the conversion formula 72 for converting the rewards for each account 61a, 61b into dollars or another currency, the annual fee 73 for each account 61a, 61b and the total dollar or other currency value 74 for each selected account. The presentation can optionally include the aggregate currency value 76 of the earned rewards 71 for each financial account 61 of the user.

System 31 can optionally include a discussion, or explanation, regarding the currency value of earned rewards from rewards programs of various financial accounts, including for example how the rewards from one financial account may be more valuable than the rewards from another financial account. Such discussion, or explanation, can include factors taken into account in determining the conversion formula 72, which can be referred to as a standardization formula, of the computerized method of the invention for a financial account, including one or more of financial accounts 61 of the user. Such discussion, or explanation, can be presented to the user in any suitable manner, for example on a linked presentation page (not shown).

In the computerized method of the invention, the rewards point of the rewards program for each financial account 61, including each financial account of the user and each financial account available to the user, is optionally standardized to permit more easy comparison of the earned rewards of one financial account 61 to the earned rewards of another financial account 61. For example, the rewards point of each financial account 61 can be converted to a standard, for example any currency including the dollar. The conversion formula 72, or standardization formula, for converting rewards points to a standard can be of any suitable type and consider any suitable factors. The conversion formula factors can include the intrinsic value of a rewards point, the availability for use of a rewards point, the transferability of a rewards point to one or more other financial accounts, the variety of redemption methods for a rewards point, how do others value a rewards point or any combination of the foregoing.

The intrinsic value of a rewards point can be calculated or determined in any suitable manner, for example by considering factors such as what a rewards point can buy and what that product is worth. For example with respect to what a rewards point can buy, a rewards program may optionally have a first conversion rate for determining how many rewards points are required to purchase some of its products, and a second conversion rate for determining how may rewards points are required to purchase other of its products or both. A rewards program may optionally have a rewards chart, under which for example one group of products costs a first predetermined number of rewards points and another group of products costs a second predetermined number of rewards points. If a card or other financial account offers “cash back”, a rewards point may be easy to value.

The availability for use of a rewards point can optionally consider whether, or how, a user can actually use the rewards point. Factors that can optionally be considered in evaluating the availability for use of a rewards point can optionally include:
Time or temporal restrictions for use of a rewards point for a given product, for example time restrictions on available hotel rooms or airline flights for purchase with rewards points;
number restrictions for use of a rewards point for a given product, for example only a certain number of airline seats are available to purchase for a certain number of rewards points;
geographic restrictions for use of a rewards point for a given product, for example only hotel rooms in a certain location or airline flights to a certain destination are available to purchase for a certain number of rewards points; and
limited availability for purchase of a product with rewards points, for example blackout dates, periods or seasons during which a product cannot be purchased with rewards points. Restrictions on the availability for use of a rewards point can optionally be a factor in devaluing the rewards point in a standardization methodology.

The transferability of a rewards point can optionally consider whether a user can move rewards points from one rewards program into other rewards programs. Such transferability can be advantageous in permitting unused rewards points in one rewards program to be moved to another rewards program in which the user can more easily use the points. For example, the user can shop around for the best deals and availability. Transferability of points can permit a user to top off points in one rewards program, by transferring points from another rewards program, to permit a desired purchase with points in the first program. Greater transferability of a rewards point can optionally be a factor in increasing the value of the rewards point in a standardization methodology.

The variety of redemption methods for a rewards point can optionally consider how many kinds of things can you purchase with rewards point. For example, some rewards programs, such as airline and hotel programs, permit rewards points to be used not only for use in the programs primary business, such as airline flights and hotel rooms, but to be used for purchasing ancillary or secondary products such as magazine subscriptions, merchandise, gift cards, and similar products. The use of rewards to purchase such ancillary or secondary products typically does not realize the best value for the rewards points, when compared for example to purchasing the primary products of the program provider. On the other hand, some rewards programs offer valuable redemption options that increase the value of rewards points. For example, a rewards program may permit a user to convert rewards points into currency at a favorable rate, for example one rewards point per one cent, at any time, just as good as many cash-back cards. A rewards program may permit a user to purchase its products at a favorable rate, for example an airlines rewards program may permit a user to book travel at up to 1.5 cents per point, depending on which card the user has. More options for redeeming rewards points can optionally be a factor in increasing the value of the rewards point in a standardization methodology. How much value a user receives under those options can be a factor in valuing rewards points in a standardization methodology.

How others value a rewards point can be a factor in valuing rewards points in a standardization methodology of the computerized method of system 31.

In the computerized method of the invention, system 31 can optionally model how much the user or consumer would have saved had the consumer used a different financial account or a plurality of different financial accounts, for example a different credit or other card or a portfolio of different credit or other cards. These various values can optionally be presented to the user along with easy ways to filter based on user preference.

The calculations of the system and program can include any number of suitable algorithms, including any or all of the following. In this regards, the computerized method of system 31 can analyze the data from one or more of the selected financial accounts, for example the transaction history of one or more or each of the selected financial accounts 61 of the user to optionally map the transaction history of the user on to one or more of a plurality of additional financial accounts, such as credit cards. The additional financial accounts can optionally include one or more existing financial accounts of the user, including one or more of the selected financial accounts of the user. The computerized method of system 31 can optionally analyze such data to determine any savings, for example rewards, that would be earned by the user as a function of the transaction history for each of the plurality of additional financial accounts.

The savings to the user can be of any suitable type, and can include the rewards of any rewards program associated with an additional financial account or otherwise. The rewards can optionally be referred to as spending rewards. Each additional financial account can be referred to as a hypothetical account. The savings can include rewards points, category bonus points, category credits, merchant bonus points, merchant credits, sign-up bonuses, base spending bonuses, discounts, cash back to the user, any new variables that may benefit the user or any combination of the foregoing.

As part of the modeling or analyzing step, the computerized method of system 31 can optionally calculate the number of rewards points that would have been earned by each additional or hypothetical credit card or other financial account. The additional or hypothetical accounts can optionally be similar to or the same type as the selected financial account or accounts of the user. For example, if the selected financial account or accounts of the user is one or more credit cards, the additional or hypothetical accounts can include or optionally consist of credit cards.

With respect to base spending bonuses, many credit cards earn one rewards point, or whatever its currency may be, per dollar spent. However, some credit cards have higher levels of base spend, for example 1.5 rewards points or two rewards points per dollar spent, and sometimes require that certain thresholds or conditions be met before the base spending bonus applies.

As part of the modeling or analyzing step, the computerized method of system 31 can optionally determine any savings that would be earned by the user for at least some of the spending categories for each of the plurality of additional or hypothetical accounts, or can optionally determine any savings that would be earned by the user for each of the spending categories for each of the plurality of additional or hypothetical accounts. With respect to category bonuses, some credit cards or other financial accounts offer additional points or rewards per dollar spent in certain categories. For example, a credit card may offer three points per dollar spent on travel or four points per dollar spent on groceries. If the user spends less than the certain amount on travel during the year, however, the user would receive a credit only in the amount spent. The computerized method of system 31 can optionally analyze each and every transaction in the user's financial account and determine a spending category for that transaction. For each spending category, the computerized method can optionally model for every other card or other financial account profile in its database how many points would have been earned on every other card in bonuses that exist thereon for that category. Considering that most credit cards have different bonus categories and values, this part of the computerized method of system 31 can be very complicated.

With respect to merchant bonuses, some cards or other financial accounts offer additional bonus points for specific merchants. For example, some airlines and hotels have co-branded cards, and may give a user one mile or rewards point for every dollar spent normally by the user but two miles or rewards points for every dollar spent on purchases from the company cobranded on the card. The computerized method of system 31 can optionally analyze the transaction history of the selected financial account or accounts of the user for transactions with merchants that may offer bonuses on one or more of the plurality of additional or hypothetical accounts. The variety and complexity of merchant bonuses can make the calculation of these savings very difficult.

With respect to sign-up bonuses, it is common that a new card will offer significant bonuses as an incentive for a user to sign up for the new card. These bonuses can range, for example, from 10,000 rewards points to as high as 100,000 rewards points.

As part of the modeling or analyzing step, the computerized method of system 31 can optionally standardize the savings that would be earned by the user for each of the plurality of additional or hypothetical credit cards or other financial accounts. Any suitable method can be used for standardizing the savings from each of the additional or hypothetical financial accounts, including for example the standardization methodology discussed above. For example, the computerized method of system 31 can optionally convert the savings, such as rewards points, for each of the additional or hypothetical financial accounts to a common currency, for example dollars, to more easily compare the savings of each additional account to the savings of other additional accounts and optionally to the savings of the current financial accounts of the user.

As part of the modeling or analyzing step, the computerized method of system 31 can optionally determine any discounts that would be earned by the user for each of the plurality of additional or hypothetical accounts. Some credit cards or other financial accounts offer statement credits for certain categories or types of spending. For example, a credit card may offer a certain amount of currency credit for travel spending during the year. Any travel spend by a user up to that amount is rebated on the card's statement. Other cards or other financial accounts offer discounts over the course of a period of time, for example over a year or month, towards certain types of spending. For example, one card may offer an application or package of a specified value every certain number or years. Another card may offer a dollar value of credit towards purchases from a specific merchant credit certain number of months that does not roll over to the following month.

As part of the modeling or analyzing step, the computerized method of system 31 can optionally calculate or determine any additional benefits of each additional or hypothetical financial account. The additional benefits can be of any type. For example, an additional benefit considered by the computerized method can optionally be lounge access. In this regard, some rewards programs offer access to private airport lounges or other airport lounge networks, which can be of value to a user. An additional benefit can optionally include premier status. In this regard, some financial accounts offer “Gold” status levels for certain hotels or airlines, which can be of value to a user. An additional benefit can optionally include premier qualification. In this regard, some financial accounts permit the user to earn premier or gold qualifying points that one would normally only get by flying or staying at a hotel. For example, a user might need to a certain number of miles on a certain airline to achieve premier or gold status on that airline. But if the user has a credit card cobranded by such airline, the user could earn up to a number less than the certain number of miles from credit card spending and would only then need to fly the balance number of miles to earn premier or gold qualifying status on that airline. An additional benefit can optionally include free nights at a hotel or other accommodation. For example, hotel credit cards offer a user of the card a free night, or multiple free nights, per year. There may be other unique benefits of one or more of the additional or hypothetical financial accounts, which can be valued and added into the calculation of the computerized method.

As part of the modeling or analyzing step, the computerized method of system 31 can optionally calculate or determine any costs to a user for each additional or hypothetical financial account. A cost can optionally include an annual fee. The computerized method and system 31 can optionally account for annual fees of a card or financial account, which are frequently waived or reduced in the first year but charged in the second or a later year. A cost can optionally include late fees. For example, if the user has a history of late fees under some or all of the current or selected financial accounts of the user, the issuer of an additional or hypothetical financial account, such as a credit card, may charge a late fee that is more or less than the late fee under the current financial account or accounts. A cost can optionally include interest charges. For example, if the interest charges under a current financial account or card can be determined, the computerized method can model what the user might pay in interest if the user has an outstanding balance on the current financial account in comparison to the interest the user would pay under one or more hypothetical financial accounts on the outstanding balance. A cost can optionally include a foreign exchange fee. For example, the computerized method can determine what transactions may have been done outside of the United States and then model if such transactions would be subject to foreign exchange fees on one or more hypothetical financial accounts.

The computerized method of system 31 can optionally sum all of the savings and subtract all of the costs for each additional or hypothetical financial account to arrive at a net savings for each of the additional or hypothetical financial accounts. For example, for each of the additional accounts the aggregate rewards points, as standardized, and any discounts and any additional benefits can be summed and any costs of the additional account subtracted therefrom to arrive at the net savings of the additional account. It is appreciated that the computerized determination of savings algorithm of system 31 can include less than all of the foregoing steps, only parts of some of the foregoing steps, additional steps or any combination of the foregoing and be within the scope of the invention.

The computerized method of system 31 can optionally deliver to the user a recommendation for optimizing financial account savings, for example credit card savings, that includes using at least one of a plurality of additional financial accounts. In this regard, for example, the computerized method can add up all of calculations with respect to prospective savings on one or more additional or hypothetical cards or other financial accounts and optionally provide an estimate of how many rewards points the user would earn in the next year, and optionally in future years when subtracting any sign-up bonus, by switching to one or more additional cards or other financial accounts or optionally by using one or more additional cards or financial accounts in addition to one or more of existing cards or financial accounts of the user.

A sample presentation to the user, for example communicated to display 39 of client computing device 32 of the user, of the prospective savings on one or more additional or hypothetical cards or other financial accounts is shown in FIG. 2. The presentation can optionally be a webpage, signed into by the user and thus customized for the user, for example Customer A in FIG. 2. The presentation can optionally include a summary of the savings on the selected financial accounts 61 of the user accessed by system 31, for example first user account 61a and second user account 61b. The presentation can optionally include the aggregate currency value 76 of the savings or rewards on such user financial accounts, for example as calculated on FIG. 4. The presentation can optionally identify several additional or hypothetical financial accounts 86, for example Card 1, Card 2 and Card 3, and can optionally include the respective aggregate currency value 87 of savings for each of the identified additional or hypothetical financial accounts 86, for example as determined above. The presentation can optionally include the recommended additional financial account 86a, for example based on the aggregate currency value 87 for such account. The webpage page or presentation of FIG. 2 can optionally include links 88 to other relevant pages provided by the computerized method of system 31. The webpage or presentation of FIG. 2 can optionally be the initial webpage presented to the user following the computerized method of system 31 analyzing the selected financial accounts 61 provided by the user.

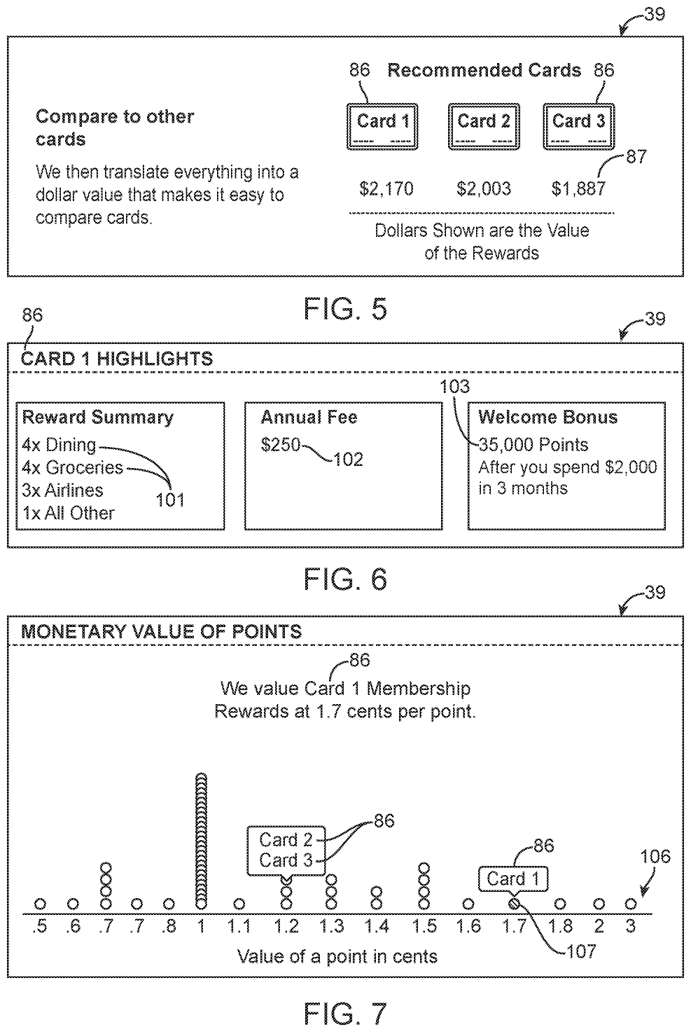

A sample presentation to the user, for example communicated to display 39 of client computing device 32 of the user, similar to FIG. 2 is shown in FIG. 5. The presentation of FIG. 5 optionally identifies several additional or hypothetical financial accounts 86, for example Card 1, Card 2 and Card 3, and can optionally include the respective aggregate currency value 87 of savings for each of the identified additional or hypothetical financial accounts 86. The webpage or presentation of FIG. 5 can optionally be a webpage presented to the user after leaving the presentation of FIG. 2, for example by clicking on the link 88 of FIG. 2 entitled Recommendations.

The computerized method of system 31 can optionally provide the user with information with respect to any or all of the hypothetical or additional financial accounts, including for example any or all of the additional accounts recommended by the computerized method. Such information can include any of the information or factors of the additional account relevant to or utilized by the algorithm of the computerized method, for example any or all of the savings or costs of the additional account.

A sample presentation of certain savings of an additional financial account 86, for example communicated to display 39 of client computing device 32 of the user, is shown in FIG. 6. The presentation of FIG. 6 optionally provides certain information with respect to an identified additional or hypothetical financial account 86, for example Card 1, such as certain category bonuses 101, the annual fee 102 and the sign-up or welcome bonus 103 of Card 1. The presentation can optionally include the savings multiplier for any or all of the savings included therein, for example category bonuses.

A sample presentation of the monetary or standardized value of a rewards points of one or more recommended additional financial accounts 86, for example communicated to display 39 of client computing device 32 of the user, is shown in FIG. 7. The presentation of FIG. 7 optionally provides the standardized value, for example the currency value, of the rewards points of certain recommended additional or hypothetical financial accounts 86. The presentation of FIG. 7 optionally provides a numbered line graph 106 depicting the standardized value 107 of the rewards point for a large number of financial accounts, for example some or all of the financial accounts included in the database of system 31 for use in the computerized method of the system, and identifies the standardized rewards point value 107 for each of the certain recommended financial accounts 86 on the graph so as to indicate the standardized value of each identified rewards point 107 and its value relative to the standardized rewards point value of the large number of financial accounts depicted on the graph.

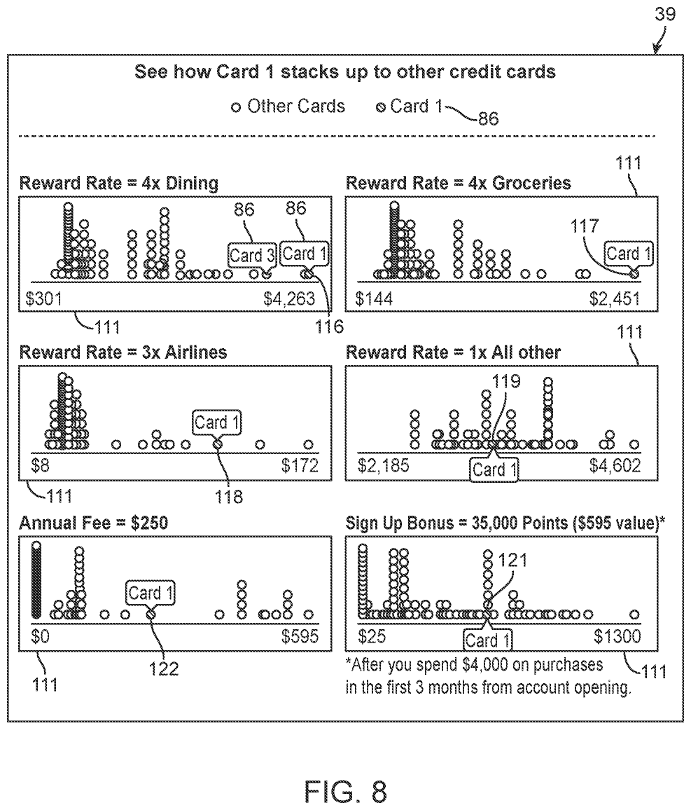

A sample presentation of the monetary or standardized value of certain savings of one or more recommended additional financial accounts 86, for example communicated to display 39 of client computing device 32 of the user, is shown in FIG. 8. The presentation of FIG. 8 optionally provides the standardized value, for example the currency value, of savings of certain recommended additional or hypothetical financial accounts 86. The presentation of FIG. 8 optionally provides a numbered line graph 111 for one or more savings, one or more costs of any combination of the foregoing for a large number of financial accounts, for example some or all of the financial accounts included in the database of system 31 for use in the computerized method of the system. FIG. 8 identifies the standardized savings value for each of the identified savings and a standardized cost value of each of the identified costs. The respective standardized savings value for each of the large number of financial accounts is shown on each savings line graph 111 and the respective standardized cost value for each of the large number of financial accounts is shown on each cost line graph 111. The standardized savings value of each of the certain recommended financial accounts 86 is shown on each of the savings line graphs, and the standardized cost value of each of the certain recommended financial accounts 86 is shown on each of the cost line graphs, so as to compare the standardized value of each standardized savings or cost of a recommended account to the standardized savings value or standardized cost value of the large number of financial accounts depicted on the respective line graph 111. FIG. 8 optionally identifies the standardized savings value for certain category bonuses for each of the certain recommended accounts 86 in a respective line graph 111, specifically the standardized dining rewards value 116, the standardized groceries rewards value 117, the standardized airlines rewards value 118, as well as the standardized remaining rewards value 119 for the remaining rewards offered by each of the certain recommended accounts 86. FIG. 8 optionally identifies the sign up bonus 121 for each of the certain recommended accounts 86 in a line graph 111. FIG. 8 optionally identifies the annual fee 122 for each of the certain recommended accounts 86 in a line graph 111. The presentation can optionally include the savings multiplier for any or all of the savings included therein.

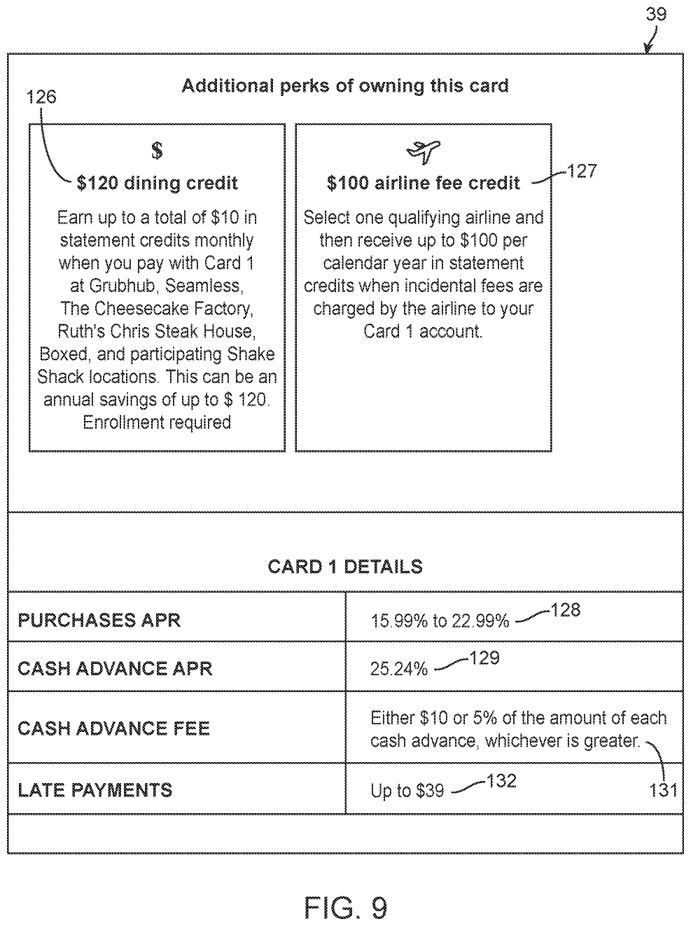

A sample presentation of certain additional benefits and certain costs of a certain additional or hypothetical financial account 86, for example communicated to display 39 of client computing device 32 of the user, is shown in FIG. 9. The presentation of FIG. 9 optionally provides the dining credit 126, and certain related textual information, the airline fee credit 127, and certain related textual information, the interest rate 128 pertaining to purchases, the interest rate 129 pertaining to cash advances, the cash advance fee 131 and the late payment charges 132 with respect to the certain account 86, specifically recommended Card 1.

The computerized method of system 31 can optionally provide the user with summary information, for example summary pages, with respect to any certain recommended hypothetical or additional financial account. Such summary information can be of any suitable type, including for example the total savings or rewards that the user would earn under the account, a graphical breakdown of the total savings, the standardized value of the total savings, a graphical breakdown of the standardized value of the total savings, a rating of the account, a textual or other summary of the savings highlights of the account, a link for the user to apply for the account or any combination of the foregoing.

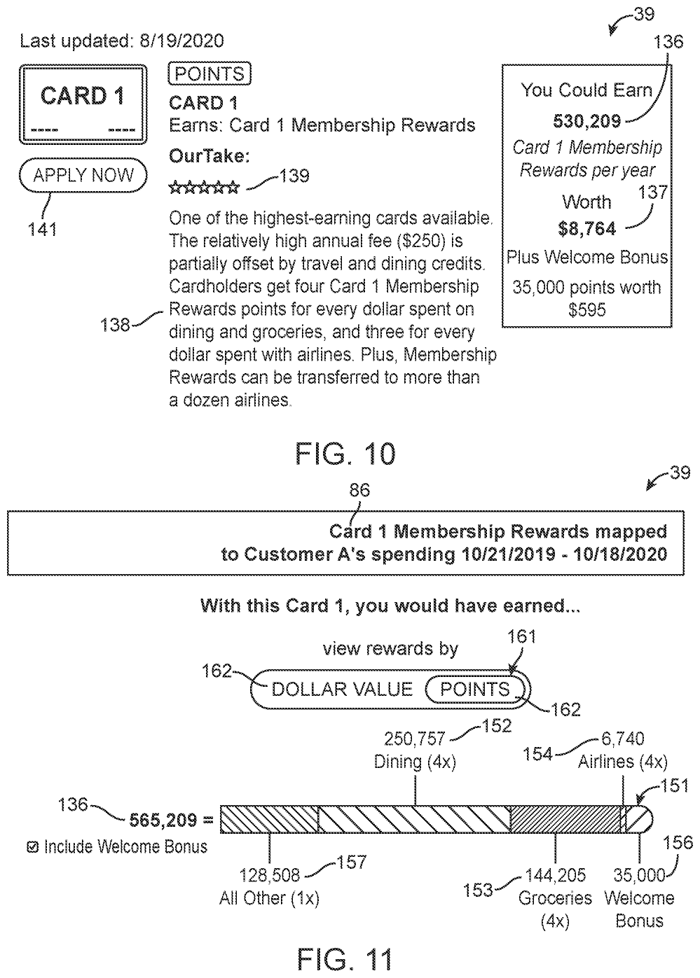

A sample presentation of certain summary information of a recommended additional or hypothetical financial account 86, for example communicated to display 39 of client computing device 32 of the user, is shown in FIG. 10. The presentation of FIG. 10 optionally identifies the recommended account 86, specifically Card 1, provides the total savings or rewards 136 that the user would earn under the identified account 86, the standardized value 137 of such total savings, a textual summary 138 of certain savings highlights of the recommended account 86, a computer-generated or partially computer-generated rating 139 of the recommended account and a link 141 for the user to apply for the recommended account 86.

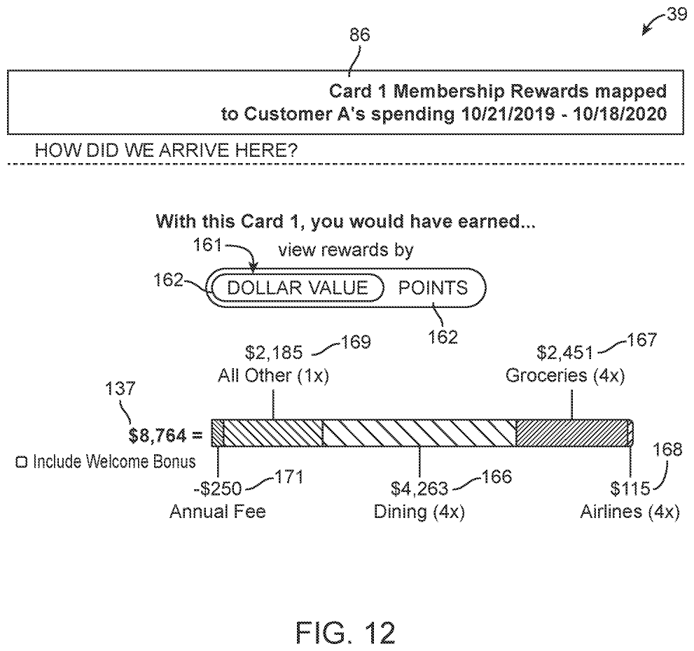

A sample presentation of certain summary information of a recommended additional or hypothetical financial account 86, for example communicated to display 39 of client computing device 32 of the user, is shown in FIGS. 11 and 12. The presentation of FIG. 11 optionally identifies the recommended account 86, specifically Card 1, and optionally provides savings information, for example as rewards points, for the recommended account generated from the transaction or spending data of the user obtained and analyzed by system 31. The savings information can optionally be mapped from the user's data for any specified time period, for example selected by the user or system 31. The presentation of FIG. 11 optionally provides the total savings or rewards 136 that the user would earn under the identified account 86 and optionally breaks down some or all of the total savings 136 in any suitable manner, for example by savings category. The savings breakdown can optionally be shown or represented in any suitable graphical form, for example in a bar graph 151. The total savings 136 in FIG. 11 has been broken down, both in numbers and on graph 151, to identify dining savings 152, groceries savings 153, airline savings 154, welcome bonus 156 and all remaining savings 157. The presentation can optionally include the savings multiplier for any or all of the savings categories included therein.

The savings illustrated in FIGS. 11 and 12 can optionally be depicted as either reward points or in standardized values, for example a currency value such as dollars. The presentation in such figures can optionally include an indicator 161 that states whether the savings are presented as reward points or in standardized values. The indicator 161 can optionally include icons 162, which can be activated by the user to display the savings as either reward points or in standardized values. As stated above, the savings in FIG. 11 are presented as rewards points. The icon 162 for Points in indicator 161 is highlighted in FIG. 11 to indicate that the savings are shown thereon as rewards points.

The computerized method of system 31 can optionally provide the user with a presentation, for example communicated to display 39 of client computing device 32 of the user, in which the savings information obtained from the transaction or spending data of the user is shown in standardized values. The presentation in FIG. 12 shows the savings in standardized values, and optionally shows the savings information of FIG. 11 in standardized values. The presentation in FIG. 12 is optionally similar to the presentation in FIG. 11. The presentation of FIG. 12 can optionally provide the standardized value of the total savings 137 that the user would earn under the identified account 86 and optionally breaks down some or all of the total standardized savings 137 in any suitable manner, for example by savings category. The total standardized savings breakdown can optionally be shown or represented in a suitable graphical form, for example in bar graph 151. The total standardized savings 137 in the bar graph 151 of FIG. 12 has been broken down, both in numbers and on graph 151, to identify standardized dining savings 166, standardized groceries savings 167, standardized airline savings 168, standardized remaining savings 169 and the annual fee 171, as a deduction. The presentation can optionally include the savings multiplier for any or all of the savings categories included therein. Although not shown therein, it is appreciated that welcome bonus 156 can optionally be included in the standardized savings breakdown, and in bar graph 151. The icon 162 for Dollar Value in indicator 161 is highlighted in FIG. 12 to indicate that the savings are shown thereon in dollars.

The computerized method of system 31 can optionally provide the user with summary information with respect to any number of top recommended hypothetical or additional financial accounts. Such summary information can be of any suitable type, including for example the total savings or rewards that the user would earn under each of the top recommended accounts, the standardized value of the total savings for each top recommended account, a breakdown of any of the categories of savings for each top recommended account, a breakdown of any of the categories of costs for each top recommended account, a rating for each of the top recommended accounts, any number of icons for filtering the top recommended accounts by certain savings, costs or other criteria or any combination of the foregoing.

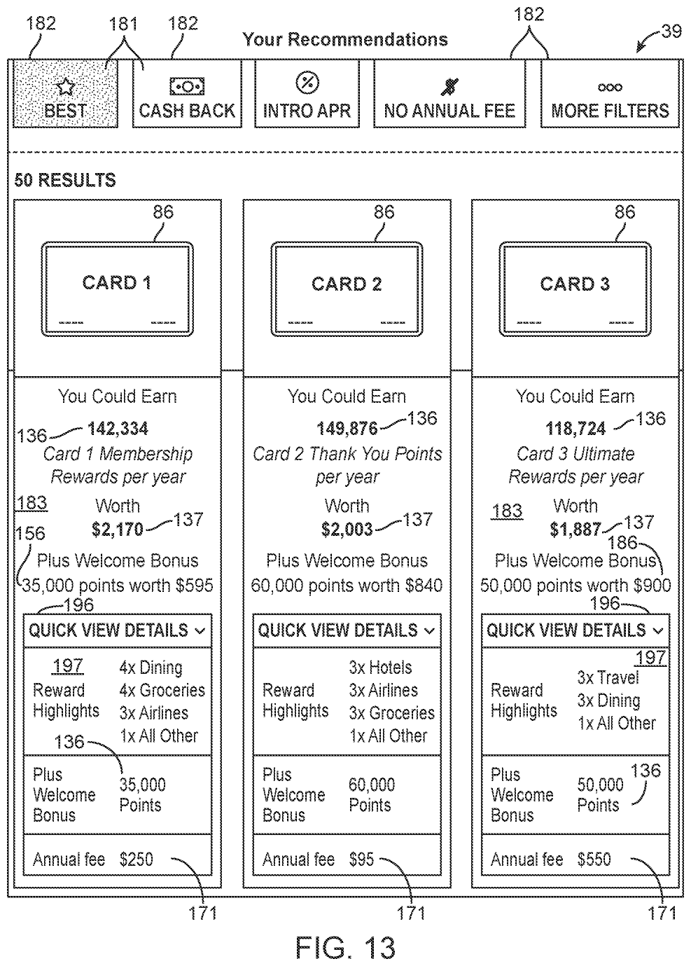

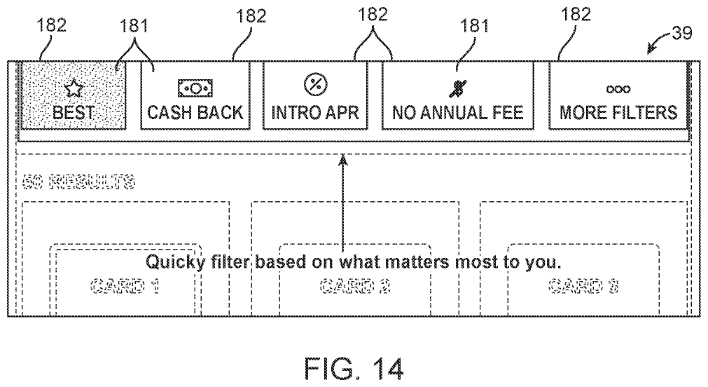

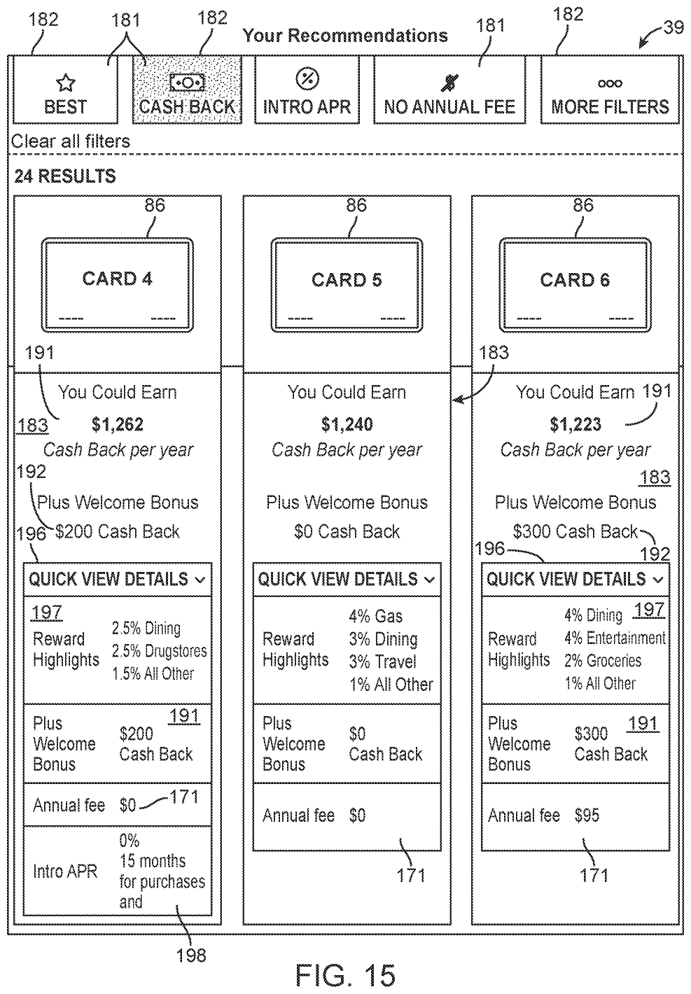

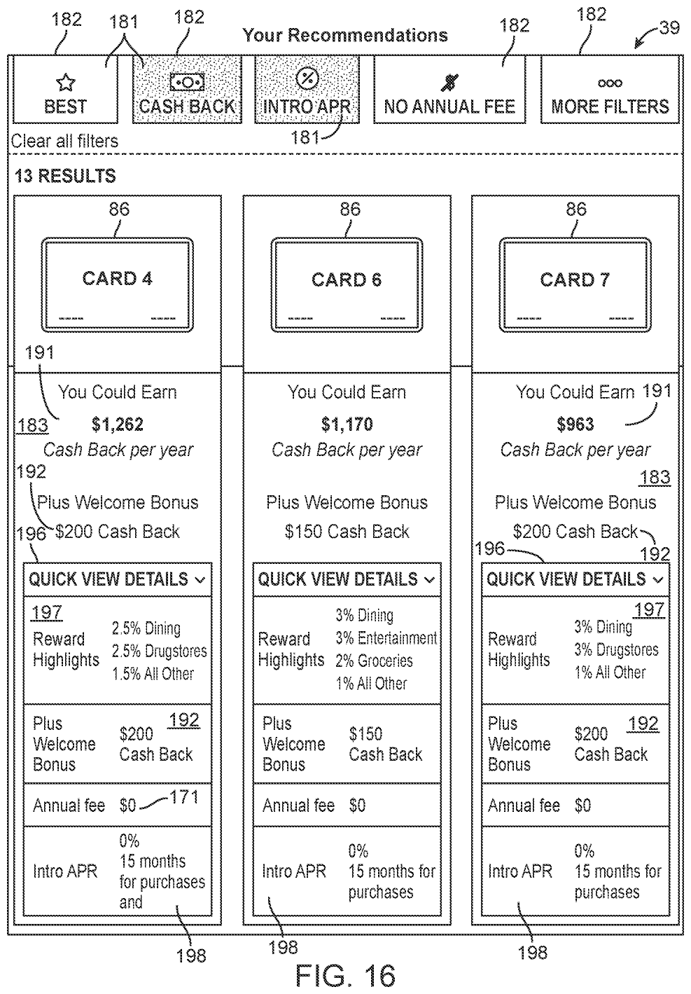

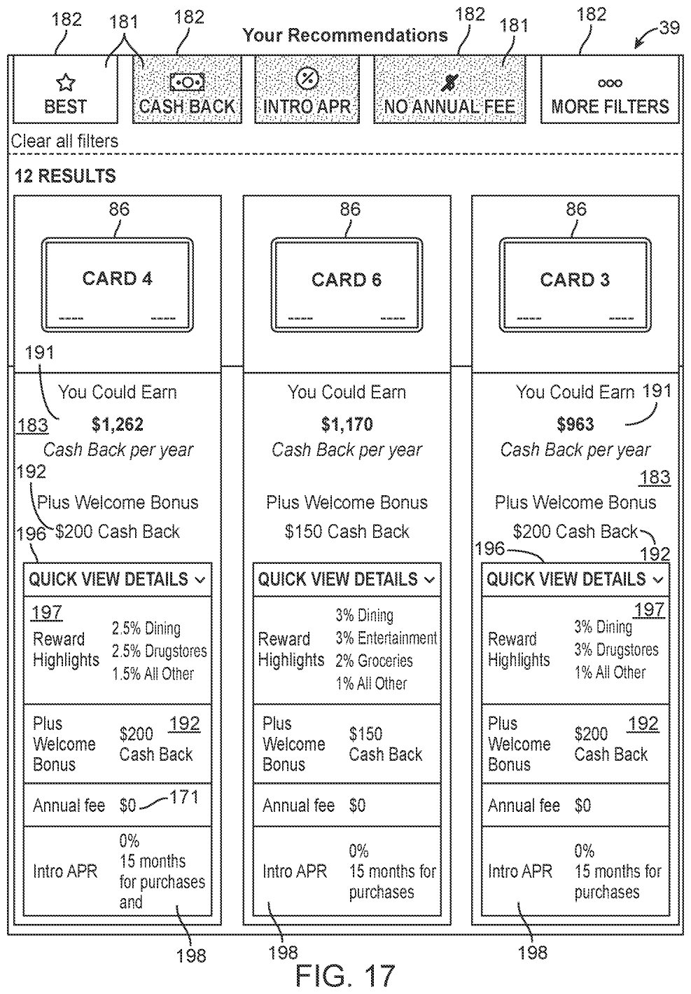

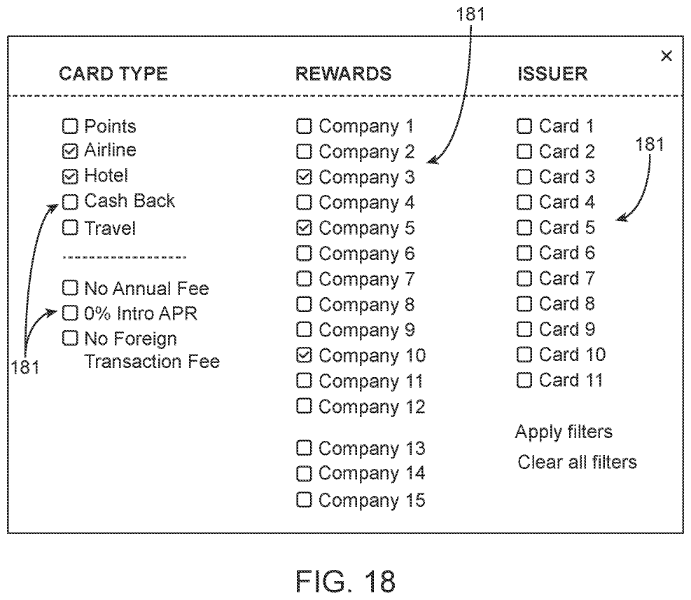

A sample presentation of certain summary information for a certain number of top recommended additional or hypothetical financial accounts 86, for example communicated to display 39 of client computing device 32 of the user, is shown in FIGS. 13-17. The presentation optionally identifies a certain plurality of top recommended additional or hypothetical accounts 86, filtered by selectable criteria 181. The filter criteria 181 can be of any suitable type, including overall best cards, cash back, any number of savings or rewards criteria, introductory interest rate, no annual fee, no foreign transaction fee, any number of cost criteria, rewards provider, card issuer, any number or card types or any other desired criteria. The presentation optionally includes a plurality of filter icons 182, for example along the top of the presentation, identifying several filter criteria 181 and permitting the selection thereof by the user. One of the filter icons 182 can optionally direct the user to a list of additional filter criteria 181, for example as shown in FIG. 18, that can be moved to the presentation and selected, selected directly or both. One or more of the filter icons 182 can be selected by the user to assemble the top recommended accounts on the presentation. For example, the Best filter criteria 181 has been selected in FIG. 13 and results in the certain plurality of overall best accounts 86, for example three accounts 86, being presented. In FIG. 15, the Cash Back filter criteria 181 has been selected, resulting in the certain plurality of top recommended accounts 86 with the best cash back savings being presented. In FIG. 16, both the Cash Back filter criteria 181 and the Introductory Interest Rate filter criteria 181 have been selected, resulting in the certain plurality of top recommended accounts 86 under both of these criteria being presented. In FIG. 17, the Cash Back filter criteria 181, the Introductory Interest Rate filter criteria 181 and the No Annual Fee filter criteria 181 have all been selected, resulting in the certain plurality of top recommended accounts 86 under these three criteria being presented.

The presentation optionally identifies the certain plurality of top recommended accounts 86 under the selected criteria and for each identified top account optionally provides a summary 183 of certain top aspects, for example certain important savings or costs, relevant to the selected filter criteria. For example, when the Best filter criteria 181 is selected, as in FIG. 13, the summary 183 for each recommended account 86 includes the total savings or rewards 136 that the user would earn under the identified account 86, the standardized total savings 137, the sign up or welcome bonus 156 and the standardized sign up or welcome bonus 186. For example, when the Cash Back filter criteria 181 is selected, as in FIG. 15, or when the Cash Back filter criteria 181 and the Introductory Interest Rate filter criteria 181 are both selected, as in FIG. 16, or when the Cash Back filter criteria 181, the Introductory Interest Rate filter criteria 181 and the No Annual Fee filter criteria 181 are all selected, as in FIG. 17, in each case the summary 183 for each recommended account 86 includes the projected annual cash back 191 and initial or welcome bonus cash back 192. For example, when the Cash Back filter criteria 181 and the Introductory Interest Rate filter criteria 181 are both selected, as in FIG. 16, the summary 183 for each recommended account 86 includes the projected annual cash back 191 and initial or welcome bonus cash back 192

The presentation optionally provides additional savings and cost information for each of the top recommended accounts under the selected filter criteria 181, for example by clicking on a Details icon 192 to reveal such additional information (see FIGS. 13 and 15-17). Such additional information for each recommended account can optionally include certain rewards highlights 197, such as rewards multipliers or rewards percentages, for the top category rewards of the recommended account. Such additional information for each recommended account can optionally include certain other relevant rewards highlights, such as the welcome bonus 136, the welcome bonus cash back 191, the annual fee 171 and the introductory interest rate 198.

It is appreciated that the system and method of the invention may utilize less than all of the foregoing steps, for example portions of one or more of the foregoing steps, only some of the foregoing steps or a combination of the foregoing, and include additional steps, and be within the scope of the invention.

The system and program can optionally use a credit score like device, or other suitable means, to show the user how well they are currently doing regarding savings with their current one or more credit cards or other financial accounts. As part of this process, the system and program can optionally calculate how much the user is saving from their current one or more credit cards.

I claim:

1. A computer-implemented method for optimizing the selection of a credit card by a user, comprising providing a transaction history of the user on an existing spending account of the user to at least one computer and causing the at least one computer to analyze the transaction history to determine any savings earned by the user on the existing spending account over the transaction history, to map the transaction history of the user on to each of a plurality of additional credit cards, to determine any savings that would be earned by the user as a function of the transaction history for each of the plurality of additional credit cards and to deliver to the user a recommendation for optimizing credit card savings that includes using at least one of the plurality of additional credit cards.

2. The method of claim 1, wherein the existing spending account is selected from the group consisting of a credit card account, a debit account, a checking account, a savings account, an investment account and any combination of the foregoing.

3. The method of claim 1, wherein the savings are selected from the group consisting of points, category bonus points, category credits, merchant bonus points, merchant credits, sign-up bonuses, base spending bonuses, cash back to the user, any new variables that may benefit the user or any combination of the foregoing.

4. The method of claim 1, wherein the step of causing the at least one computer to analyze the transaction history includes determining the amount of spending of the user in each of a plurality of predetermined spending categories and wherein the step of causing the at least one computer to determine any savings that would be earned by the user as a function of the transaction history for each of the plurality of additional credit cards includes determining any savings that would be earned by the user for at least some of the spending categories for each of the plurality of additional credit cards.

5. The method of claim 4, wherein the plurality of predetermined spending categories are selected from the group consisting of base spending, travel, airfare, groceries, dining, entertainment, hotels, office supplies, business, merchants, home improvement and any combination of the foregoing.

6. The method of claim 1, further comprising the step of standardizing the savings that would be earned by the user as a function of the transaction history for each of the plurality of additional credit cards.

7. The method of claim 6, wherein the step of standardizing the savings includes providing a dollar value for the savings that would be earned by the user as a function of the transaction history for each of the plurality of additional credit cards.

8. The method of claim 1, further comprising the step of causing the at least one computer to determine the value of any additional benefits that would be earned by the user as a function of the transaction history for each of the plurality of additional credit cards, and wherein the step of causing the at least one computer to deliver to the user a recommendation includes causing the at least one computer to deliver to the user a recommendation for optimizing credit card savings and benefits that includes using at least one of the plurality of additional credit cards.

9. The method of claim 8, wherein the additional benefits are selected from the group consisting of lounge access, premier status, premier qualification, free hotel nights and any combination of the foregoing.

10. The method of claim 1, wherein the step of causing the at least one computer to determine any savings that would be earned by the user as a function of the transaction history for each of the plurality of additional credit cards includes causing the at least one computer to determine any costs that would be charged to the user as a function of the transaction history for each of the plurality of additional credit cards and reflecting the costs in the savings that would be earned by the user for each of the plurality of additional credit cards.

11. The method of claim 10, wherein the costs are selected from the group consisting of annual fees, late fees, interest charges, foreign exchange fees and any combination of the foregoing.

12. A computer-implemented method for optimizing the selection of a financial account by a user, comprising providing a transaction history of the user on an existing financial account of the user to at least one computer and causing the at least one computer to map the transaction history of the user on to each of a plurality of additional financial accounts, to determine any benefits that would be earned by the user as a function of the transaction history for each of the plurality of additional financial accounts and to deliver to the user a recommendation for optimizing benefits that includes using at least one of the plurality of additional financial accounts.

13. The method of claim 12, wherein the transaction history is a spending history of the user on the existing financial account of the user.

14. The method of claim 12, wherein the providing step includes providing a transaction history of the user on a plurality of existing financial accounts of the user to at least one computer.

15. The method of claim 12, wherein the benefits are selected from the group consisting of savings and spending rewards.

16. The method of claim 12, wherein the recommendation includes a computer-generated comparison of certain benefits of each of the plurality of additional financial accounts.

17. The method of claim 12, wherein the recommendation is a function of a plurality of benefits selected by the user.

18. A computer-implemented method for optimizing the selection of a credit card by a user, comprising providing a transaction history of the user on an existing spending account of the user to at least one computer and causing the at least one computer to analyze the transaction history to determine any savings earned by the user on the existing spending account over the transaction history, to map the transaction history of the user on to each of a plurality of additional credit cards, to determine any savings that would be earned by the user as a function of the transaction history for each of the plurality of additional credit cards and to deliver to the user an optimization score determined as a function of any savings earned by the user on the existing credit card and any savings that would be earned by the user for each of the plurality of additional credit cards.

19. The method of claim 18, wherein the existing spending account is selected from the group consisting of a credit card account, a debit account, a checking account, a savings account, an investment account and any combination of the foregoing.
